(19) United States
(12) Patent Application Publication
(10) Pub. No.: US 2025/0187898 A1
(43) Pub. Date: Jun. 12, 2025

(54) COLD WATER TANK ASSEMBLY

(71) Applicant: COWAY Co., Ltd., Gongju-si (KR)

(72) Inventors: Sung Jae LEE, Gongju-si (KR); Myung Jin PARK, Gongju-si (KR); Sang Gu SIM, Gongju-si (KR); Sung Jin KIM, Gongju-si (KR); Bong Suk KIM, Gongju-si (KR); Byung Hyo YE, Gongju-si (KR)

(73) Assignee: COWAY Co., Ltd., Gongju-si (KR)

(21) Appl. No.: 18/962,473

(22) Filed: Nov. 27, 2024

(30) Foreign Application Priority Data
Dec. 6, 2023 (KR) 10-2023-0175547

(51) Int. Cl. B67D 1/08

(52) U.S. Cl. CPC B67D 1/0859; B67D 1/0801; B67D 2210/00049

(57) ABSTRACT

A cold water tank assembly is disclosed. A cold water tank assembly according to an aspect of the present invention may include a cold water tank having an accommodation space, a partition wall that divides the accommodation space of the cold water tank into a plurality of heat exchange flow path zones, and an evaporator that sequentially passes through the heat exchange flow path zones.

### CROSS-REFERENCE TO RELATED APPLICATION

This application claims priority to and the benefit of Korean Patent Application No. 10-2023-0175547, filed on Dec. 6, 2023, the disclosure of which is incorporated herein by reference in its entirety.

### TECHNICAL FIELD

The present invention relates to a cold water tank assembly, and more particularly, to a cold water tank assembly capable of being miniaturized, increasing cooling efficiency compared to capacity and maximizing cold water extraction amount by increasing contact time and area between an evaporator and purified water in a limited space.

### RELATED ART

In general, water purifiers, carbonated water machines, and cold and hot water dispensers are equipped with cold water tanks to cool purified water at room temperature to generate low-temperature purified water (water) and supply it to users.

Taking a water purifier as an example, such a cold water tank includes an inlet pipe and an outlet pipe to communicate with the inner space, and purified water at room temperature filtered through one or more filters is introduced and stored in the inner space.

In addition, the purified water (water) at room temperature stored through an evaporator (cooling pipe) provided in the cold water tank is cooled to a set temperature and extracted as purified water (water) at a low temperature so that users can drink or use purified water (water) at a temperature lower than room temperature.

For example, in Korean Patent Laid-Open Publication No. 10-2023-0062080, a structure in which an evaporator is provided in the inner space of a cold water tank to cool stored purified water has been disclosed.

Such a cold water tank has a quadrangular shape, and the internal accommodation space for fluid is divided into multiple zones using multiple transverse partition walls, the evaporator is arranged to pass through each zone, and purified water flowing from the top passes through each zone and is cooled into low-temperature purified water (cold water) and discharged.

However, in the cold water tank configured in this way, the partition walls are alternately arranged in the horizontal direction in the accommodation space, so that the flow of purified water has a flow from upward to downward, and accordingly, there was a problem in that cooling efficiency and cold water extraction amount were reduced due to insufficient time for contact between the purified water at room temperature and the evaporator.

In other words, since the introduced purified water at room temperature flows downward according to its own weight and is cooled while being in contact with the evaporator in the flow path zone and is extracted as purified water at low-temperature, it was difficult to reduce the size of the cold water tank in the limited water purifier space compared to the capacity due to the partition walls installed only in the lateral direction, and there was a problem in that purified water extracted to the outside with insufficient contact time and contact area between the purified water and the evaporator due to the flow of purified water flowing only downward.

As the current water purifier seeks more miniaturization, these conventional cold water tanks have poor cold water efficiency (the value obtained by dividing the cold water extraction amount by the tank capacity), and thus, there is a problem in that the user's satisfaction is poor because it is difficult to obtain as many low-temperature purified water (cold water) as the user wants.

Accordingly, in constructing a cold water tank in a water purifier, etc., there is an urgent need to develop a cold water tank assembly capable of optimally exhibiting the original function of the cold water tank and increasing user satisfaction by being further miniaturized, increasing space efficiency, and increasing contact time and area between the evaporator and the purified water in a limited space to maximize the amount of cold water extracted while increasing the cooling efficiency compared to capacity.

### SUMMARY

The present invention aims to solve the above problems, and the present invention is directed to providing a cold water tank assembly capable of being miniaturized, increasing cooling efficiency compared to capacity and maximizing cold water extraction amount by increasing contact time and area between an evaporator and purified water in a limited space.

In addition, the present invention is also directed to providing a cold water tank assembly that can increase the contact time and contact area between the evaporator and the purified water while having a flow of purified water (water) at room temperature introduced into the accommodation space of the cold water tank that rises at least once.

The problems of the present invention are not limited to those mentioned above, and other problems not mentioned will be clearly understood by those of ordinary skill in the art from the following description.

The objects of the present disclosure are not limited to the above-described objects, and other objects that are not mentioned will be able to be clearly understood by those skilled in the art to which the present disclosure pertains from the following description.

According to an aspect of the present invention, a cold water tank assembly is provided.

The cold water tank assembly may include a cold water tank having an inlet pipe and an outlet pipe through which purified water flows, an accommodation space therein, and a length in a first direction; a partition wall part including at least one first partition wall that divides the accommodation space in a second direction in a plate shape with an XZ plane, and at least one second partition wall that crosses the first partition wall and divides the accommodation space in a third direction in a plate shape with an XY plane, and dividing the accommodation space into a plurality of heat exchange flow path zones having a length in the first direction and adjacent to each other in the second direction or third direction; and an evaporator through which refrigerant flows, the evaporator including a main line that is inserted into the accommodation space and withdrawn to the outside while sequentially passing through the plurality of heat exchange flow path zones and is arranged to pass through the heat exchange flow path zones in the first direction, and a connection line with which an end of the main line is bent so that the main line adjacent is connected.

In this case, the partition wall part may form an opening passage through which the connection line and the purified water pass while communicating the adjacent heat exchange flow path zones.

In addition, purified water at room temperature introduced into the first heat exchange flow path zone may be extracted as purified water at low temperature passing through the N^{th} heat exchange flow path zone while forming at least one rising flow in the third direction.

In this case, the first partition wall and the second partition wall may cross each other orthogonal to each other to form a lattice structure.

In this case, the main line may be arranged to pass through a center line in the first direction of the heat exchange flow path zone.

In this case, an end edge of the partition wall part may be arranged to press an inner circumferential surface of the accommodation space of the cold water tank.

In addition, as necessary, the cold water tank may include a coupling groove into which an end edge of the partition wall part is forcibly fitted, on an inner circumferential surface of the cold water tank.

In addition, the cold water tank may have a cross-sectional shape of a closed surface with a short axis in the second direction and a long axis in the third direction orthogonal to the second direction.

In this case, the cold water tank assembly may further include an insulating case configured to form an interspace between an outer circumferential surface of the cold water tank and surround the cold water tank.

Meanwhile, the interspace may form a space for vacuum insulation, or be filled with an insulating material.

In addition, the cold water tank may include a first body part having an enclosure shape and a first opening; and a second body part having an enclosure shape and a second opening in surface contact with and corresponding to the first opening the second body part being hermetically coupled to the first body part.

Meanwhile, as necessary, a part of the first partition wall or the second partition wall may be integrally formed on an inner circumferential surface of the first body part, and another part of the first partition wall or the second partition wall may be integrally formed on an inner circumferential surface of the second body part.

In addition, the cold water tank may further include a water level sensor configured to measure purified water level of the heat exchange flow path zone formed at the uppermost portion in the third direction in the accommodation space; and a temperature sensor configured to measure the temperature of any one heat exchange flow path zone of the plurality of heat exchange flow path zones.

In this case, the temperature sensor may be arranged in the first heat exchange flow path zone communicating with the inlet pipe.

In addition, the cold water tank may further include an overflow pipe configured to communicate with the heat exchange flow path zone formed at the uppermost portion in the third direction in the accommodation space.

In addition, a refrigerant flow of the evaporator and a purified water flow passing through the heat exchange flow path zone may be formed to have opposite direction flows to each other.

According to the above configuration, the cold water tank assembly according to the present invention can increase the contact area between the purified water and the evaporator by dividing the accommodation space inside the cold water tank into a plurality of heat exchange flow path zones using the first partition wall on the XZ plane and the second partition wall on the XY plane and forming the maximum heat exchange flow path zone H/A in a limited space.

In addition, the plurality of partition wall parts, including the first partition wall on the XZ plane and the second partition wall on the XY plane, divide the accommodation space into the plurality of heat exchange flow path zones having a length in the first direction and adjacent in the second direction or third direction, and make purified water to have a rising flow at least once to increase the contact time between the purified water and the evaporator to the maximum, thereby capable of increasing cooling efficiency and maximizing cold water extraction amount compared to capacity.

In addition, as the flow of refrigerant extracted by flowing into the evaporator and the flow of purified water extracted by flowing into the heat exchange flow path zone have opposite flows, the purified water extracted through the last heat exchange flow path zone can be heat-exchanged with ice formed in the evaporator by the refrigerant and be extracted as the purified water having a lower temperature.

Advantageous effects of the present invention are not limited to the above-described effects, and should be understood to include all effects that can be inferred from the configuration of the invention described in the detailed description or claims of the present invention.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1 and 2 are perspective views showing a cold water tank assembly according to an exemplary embodiment of the present invention.

FIG. 3 is a cross-sectional view taken along line I-I′ based on an inlet pipe in the cold water tank assembly according to an exemplary embodiment of the present invention of FIG. 1.

FIG. 4 is a cross-sectional view taken along line II-II′ based on an outlet pipe in the cold water tank assembly according to an exemplary embodiment of the present invention of FIG. 1.

FIG. 5 is a perspective view showing a structure including an insulating case in a cold water tank assembly according to an exemplary embodiment of the present invention.

FIG. 6 is a cross-sectional view taken along line III-III′ in the cold water tank assembly according to an exemplary embodiment of the present invention of FIG. 5.

FIG. 7 is a schematic view showing an arrangement relationship between a partition wall part and an evaporator applied to a cold water tank assembly according to an exemplary embodiment of the present invention.

FIG. 8 is a perspective view showing a cold water tank assembly according to another exemplary embodiment of the present invention.

FIG. 9 is a schematic view showing a partition wall part and an evaporator arranged in an accommodation space in the cold water tank assembly of FIG. 8.

### DETAILED DESCRIPTION OF EXEMPLARY EMBODIMENTS

Hereinafter, exemplary embodiments of the present invention will be described in detail so that those of ordinary skill in the art can readily implement the present invention with reference to the accompanying drawings. The present invention may be embodied in many different forms and is not limited to the embodiments set forth herein. In the drawings, parts unrelated to the description are omitted for clarity of description of the present invention, and throughout the specification, same or similar reference numerals denote same elements.

Terms and words used in the present specification and claims should not be construed as limited to their usual or dictionary definition. They should be interpreted as meaning and concepts consistent with the technical idea of the present invention, based on the principle that inventors may appropriately define the terms and concepts to describe their own invention in the best way.

Accordingly, the embodiments described in the present specification and the configurations shown in the drawings correspond to preferred embodiments of the present invention, and do not represent all the technical idea of the present invention, so the configurations may have various examples of equivalent and modification that can replace them at the time of filing the present invention.

It should be understood that the terms “comprise or include” or “have” or the like when used in this specification, are intended to describe the presence of stated features, numbers, steps, operations, elements, components and/or a combination thereof but not preclude the possibility of the presence or addition of one or more other features, numbers, steps, operations, elements, components, or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

The terms “X-axis,” “Y-axis,” and “Z-axis” used in the description will be understood with reference to the coordinate system shown in the drawings. In addition, the description refers to the X-axis direction as the first direction, the Y-axis direction as the second direction, and the Z-axis direction as the third direction, but this is only one example according to a relative perspective, and the first to third directions and coordinate axes (X, Y, Z axes) are introduced to explain the relative positions between components and do not limit the absolute positions of each component. In addition, it should be specified in advance that N or n, which will be described later, means an integer of 1 or more.

Additionally, in describing the present invention, detailed descriptions of related known functions or configurations will be omitted in order to not obscure the gist of the present invention.

Hereinafter, a cold water tank assembly according to an exemplary embodiment of the present invention will be described with reference to the accompanying drawings.

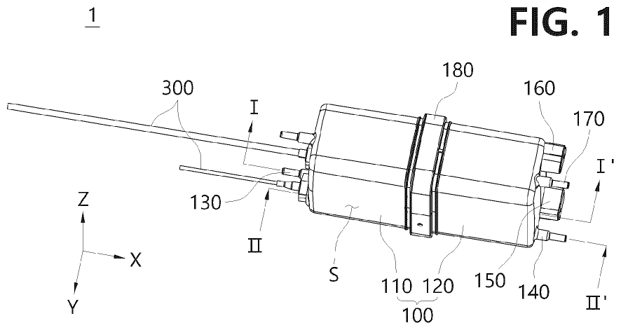

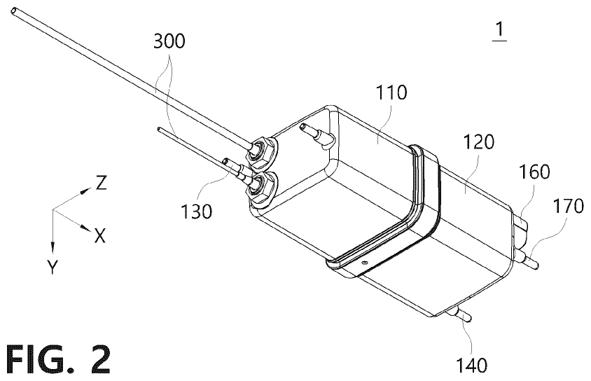

First, as shown in FIGS. 1 to 7, the cold water tank assembly according to an exemplary embodiment of the present invention provides a cold water tank assembly 1 capable of optimally exhibiting the original function of a cold water tank by increasing the cooling efficiency compared to capacity and maximizing the amount of cold water extracted by increasing the contact time and contact area between purified water introduced and an evaporator 300 while miniaturizing the size of a cold water tank 100.

To this end, the cold water tank assembly 1 according to an exemplary embodiment of the present invention largely includes a cold water tank 100 having an internal accommodation space S, a partition wall part 200 that partitions the internal accommodation space S of the cold water tank 100 into a plurality of heat exchange flow path zones H/A having a length in a first direction and adjacent to each other in a second direction or third direction, and an evaporator 300 arranged in the internal accommodation space S of the cold water tank 100 with a set length and directionality to sequentially pass through the plurality of heat exchange flow path zones H/A partitioned by the partition wall part 200.

First, the cold water tank 100 constituting the cold water tank assembly 1 according to an exemplary embodiment of the present invention has a cylindrical shape with an accommodation space S therein and has a length in the first direction. In addition, the cold water tank 100 includes an inlet pipe 130 through which purified water at room temperature flows into the accommodation space S and an outlet pipe 140 through which low-temperature purified water (cold water) flows to the outside.

In this case, for example, the cold water tank 100 may be configured to be divided into a first body part 110 with the inlet pipe 130 and a second body part 120 with the outlet pipe 140, and the first body part 110 and the second body part 120 may have a structure that hermetically couples the internal accommodation space S.

In this case, of course, the inlet pipe 130 and the outlet pipe 140 may be provided on the same body part side depending on the zone arrangement of the heat exchange flow path zone H/A to be described later.

In addition, as necessary, the cold water tank 100 may have a structure that includes a body part with an open entrance in the shape of an enclosure that forms an accommodation space S and a cap part that is coupled to cover the body part in a sealed manner, and is not necessarily limited to the combination of the first body part 110 and the second body part 120, as shown in the drawing.

However, in an embodiment of the present invention, the shape of the cold water tank 100 in which the first body part 110 having an enclosure shape and a first opening and the second body part 120 having an enclosure shape and a second opening in surface contact with and corresponding to the first opening in the same shape as the first body part 110 are hermetically coupled facing each other, as shown in the drawing, will be described as an example.

Meanwhile, the cold water tank 100 may include a temperature sensor 150, a water level sensor 160, and an overflow pipe 170 on one side as needed.

More specifically, the first body part 110 applied to the cold water tank 100 constituting the cold water tank assembly 1 according to an exemplary embodiment of the present invention has a cylindrical (enclosure) shape with the first opening open to one side in the first direction, and includes the inlet pipe 130 at the opposite part of the first opening. Additionally, the evaporator 300 is placed so that it can be drawn into the internal accommodation space and then drawn out, and the evaporator 300 can be divided into an inlet line 300a side and an outlet line 300b side.

In addition, the second body part 120 has a cylindrical (enclosure) shape with the second opening open to the other side in the first direction opposite to the first body part 110, and includes the outlet pipe 140, the temperature sensor 150, the water level sensor 160, and the overflow pipe 170 at the opposite part of the second opening.

Meanwhile, the first body part 110 and the second body part 120 have a structure in which the first opening and the second opening are combined to correspond to each other in surface contact with each other, thereby forming a single internal accommodation space S and being sealed.

To this end, the first body part 110 and the second body part 120 have a structure that is tightened and sealed by a clamp 180 (FIG. 1), and of course, the clamp 180 includes a sealing member to increase watertightness and sealability.

Since various conventional structures can be applied to the clamp 180 that connects the first body part 110 and the second body part 120 in a sealed manner, a detailed description thereof will be omitted to avoid obscuring the gist of the present invention.

As described above, the cold water tank 100 comprised of the combination of the first body part 110 and the second body part 120 may have an enclosure shape with a sealed accommodation space S, and may have a cross-sectional shape of a closed surface with a short axis in the second direction and a long axis in the third direction orthogonal to the second direction.

As necessary, the cold water tank 100 may have an elliptical shape or a rectangular shape or the like.

Then, referring to FIGS. 1 to 7, the cold water tank assembly 1 according to an exemplary embodiment of the present invention includes the partition wall part 200 that partitions the internal accommodation space S of the cold water tank 100 into a plurality of heat exchange flow path zones H/A.

In this case, the partition wall part 200 includes a first partition wall 210 and a second partition wall 220.

In this case, the first partition wall 210 has a plate shape with an XZ plane and divides the accommodation space S in the second direction, and may be composed of at least one plate. In addition, the second partition wall 220 has a plate shape with an XY plane and divides the accommodation space S in the third direction, and may be composed of at least one plate.

The first partition wall 210 and the second partition wall 220 divide the accommodation space S of the cold water tank 100 into a plurality of heat exchange flow path zones H/A having a length in the first direction and adjacent to each other in the second direction or the third direction.

In addition, the partition wall part 200 has an opening passage u1 that communicates the neighboring heat exchange flow path zones H/A and through which a connection line 320 of the evaporator 300 to be described later and the introduced purified water pass.

The opening passage u1 may have a shape in which a part of the partition wall part 200 in contact with the inner surface of the cold water tank 100 is partially cut, and of course, have a size and shape that does not interfere with the flow of the connection line 320 and purified water. For example, the opening passage u1 may be in the form of a hemisphere or semi-ellipse.

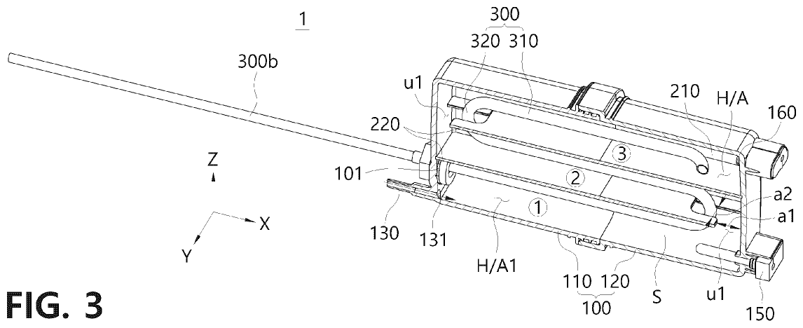

In addition, the opening passage u1 may have a structure in which a part forms a first distance a1 with the inner circumferential surface of the cold water tank 100 in the first direction and a width of a second distance a2 in the second direction, so that the evaporator 300, which will be described later, can be stably passed through, coupled and arranged (see FIG. 3).

Meanwhile, in the drawing, for example, the first partition wall 210 is composed of one plate, and the second partition wall 220 is composed of two plates, but of course, it is not limited thereto.

As shown in the drawing, one first partition wall 210 and two second partition walls 220 divide the internal accommodation space S of the cold water tank 100 into six heat exchange flow path zones H/A.

Specifically, referring to FIGS. 3, 4, 6, and 7, when the inlet pipe 130 is provided at the lower portion in the third direction of the first body part 110, the heat exchange flow path zone H/A generated by partitioning by the partition wall part 200 consists of a first heat exchange flow path zone \textcircled{1}, a second heat exchange flow path zone \textcircled{2}, a third heat exchange flow path zone \textcircled{3}, a fourth heat exchange flow path zone \textcircled{4}, a fifth heat exchange flow path zone \textcircled{5} and a sixth heat exchange flow path zone \textcircled{6}.

In this case, the first heat exchange flow path zone \textcircled{1} is formed to communicate with an inlet 131 of the inlet pipe 130 formed in the first body part 110 and have a length in the first direction. In addition, the first heat exchange flow path zone \textcircled{1} forms an opening passage u1 that opens in the third direction on the second body part 120 (see FIG. 3).

Meanwhile, the second heat exchange flow path zone \textcircled{2} communicates with the first heat exchange flow path zone \textcircled{1} through the opening passage u1 of the first heat exchange flow path zone \textcircled{1}, is disposed above the first heat exchange flow path zone \textcircled{1} in the third direction, and is formed to have a length in the first direction. In addition, the second heat exchange flow path zone \textcircled{2} forms an opening passage u1 that opens in the third direction on the first body part 110 (see FIG. 3).

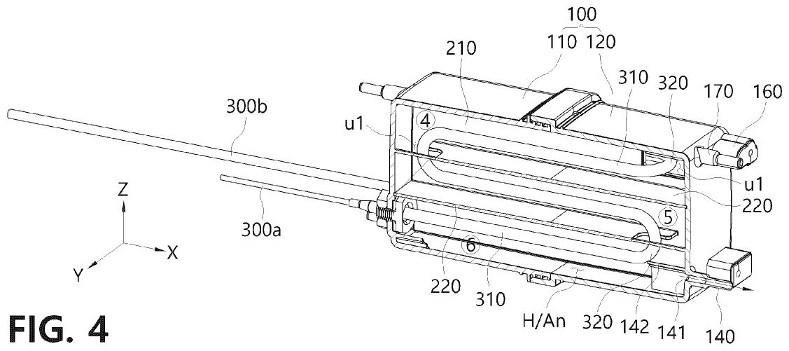

Meanwhile, the third heat exchange flow path zone \textcircled{3} communicates with the second heat exchange flow path zone \textcircled{2} through the opening passage u1 of the second heat exchange flow path zone \textcircled{2}, is disposed above the second heat exchange flow path zone \textcircled{2} in the third direction, and is formed to have a length in the first direction. In addition, the third heat exchange flow path zone \textcircled{3} forms an opening passage u1 that opens in the second direction on the second body part 120 (see FIGS. 3 and 4).

Meanwhile, the fourth heat exchange flow path zone \textcircled{4} communicates with the third heat exchange flow path zone \textcircled{3} through the opening passage u1 of the third heat exchange flow path zone \textcircled{3}, is disposed on the side of the third heat exchange flow path zone \textcircled{3} in the second direction, and is formed to have a length in the first direction. In addition, the fourth heat exchange flow path zone \textcircled{4} forms an opening passage u1 that opens in the third direction on the first body part 110 (see FIG. 4).

Meanwhile, the fifth heat exchange flow path zone \textcircled{5} communicates with the fourth heat exchange flow path zone \textcircled{4} through the opening passage u1 of the fourth heat exchange flow path zone \textcircled{4}, is disposed below the fourth heat exchange flow path zone \textcircled{4} in the third direction, and is formed to have a length in the first direction. In addition, the fifth heat exchange flow path zone \textcircled{5} forms an opening passage u1 that opens in the third direction on the second body part 120 (see FIG. 4).

Meanwhile, the sixth heat exchange flow path zone \textcircled{6} communicates with the fifth heat exchange flow path zone \textcircled{5} through the opening passage u1 of the fifth heat exchange flow path zone \textcircled{5}, is disposed below the fifth heat exchange flow path zone \textcircled{5} in the third direction, and is formed to have a length in the first direction. In this case, the sixth heat exchange flow path zone \textcircled{6}, which is the last N^{th} heat exchange flow path zone H/An, is connected to an outlet 141 of the outlet pipe 140.

In the drawing, for example, the outlet pipe 140 is formed on the lower side of the second body part 120, but the present invention is not limited thereto, and of course, the outlet pipe 140 may be formed on the first body part 110.

The position of the outlet pipe 140 may be arranged in consideration of the structure of the water purifier, the connection relationship with other modules, and so on.

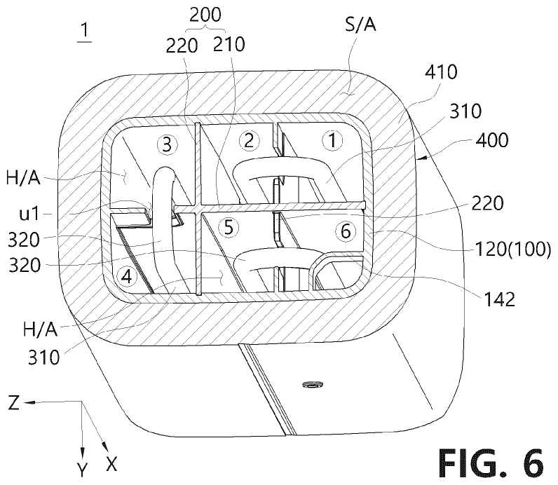

Meanwhile, the sixth heat exchange flow path zone \textcircled{6} communicating with the outlet pipe 140 includes a plate or tubular shape outlet guide 142 (FIGS. 4 and 6) having a set length so that low-temperature purified water is stably guided to the outlet 141 of the outlet pipe 140, and ice generated by the evaporator does not block the outlet 141 not to interfere with flow of low-temperature purified water.

The outlet guide 142 secures a stable guide region on the outlet 141 in the sixth heat exchange flow path zone \textcircled{6} so that low-temperature purified water may be stably extracted through the outlet 141.

As described above, the plurality of heat exchange flow path zones H/A formed in the partition wall part 200 including the first partition wall 210 and the second partition wall 220 have a structure in which they communicate with each other.

Purified water at room temperature introduced through the inlet pipe 130 into the first heat exchange flow path zone H/A1, that is, the first heat exchange flow path zone \textcircled{1} in the drawing, has no choice but to have at least one rising flow in the third direction since the above-described heat exchange flow path zone is formed by being partitioned adjacent to each other in the second direction or the third direction, and is extracted through the outlet pipe 140 as low-temperature purified water (cold water) by exchanging heat with the evaporator 300 to be described later disposed in the heat exchange flow path zone H/A while passing through the N^{th} heat exchange flow path zone H/An, that is, the sixth heat exchange flow path zone \textcircled{6} in the drawing.

Meanwhile, the above-described partition wall part 200, that is, the first partition wall 210 and the second partition wall 220, may already cross each other orthogonal to each other to have a lattice structure, and may be disposed in the accommodation space S before the first body part 110 and the second body part 120 are combined.

In this case, the first partition wall 210 and the second partition wall 220 may be formed of a hard material, or may be partially or entirely formed of a soft material. In other words, of course, the materials of the first partition wall 210 and the second partition wall 220 are not limited and may be changed as necessary.

Meanwhile, the end edge of the partition wall part 200 is placed while pressing the inner circumferential surface of the accommodation space S of the cold water tank 100 to block the penetration of purified water through the edge gap. Accordingly, the introduced purified water is completely moved along only the heat exchange flow path zone H/A to achieve heat exchange.

Meanwhile, the partition wall part 200 may have a form in which the end edge is forcibly fitted into a coupling groove 101 formed on the inner circumferential surface of the cold water tank 100.

In other words, the cold water tank 100 has a coupling groove 101 to which the end edge of the partition wall part 200 is forcibly fitted, on the inner circumferential surface of the accommodation space S. In this case, the coupling groove 101 has a set length corresponding to the entire end of the partition wall part 200 (see FIG. 3).

Meanwhile, in order to increase the ease of assembly of the cold water tank assembly 1, the partition wall part 200 may be already integrally coupled or molded to the inner circumferential surface of the first body part 110 or the second body part 120 constituting the cold water tank 100 and be arranged in the accommodation space according to the combination of the first body part 110 and the second body part 120.

In other words, a part constituting the first partition wall 210 or the second partition wall 220 may be integrally formed on the inner circumferential surface of the first body part 110, and another part of the first partition wall 210 or the second partition wall 220 may be integrally formed on the inner circumferential surface of the second body part 120.

Additionally, when the first body part 110 and the second body part 120 are hermetically combined, the first partition wall 210 and the second partition wall 220 intersect and have a lattice structure, dividing the accommodation space into a plurality of heat exchange flow path zones H/A.

Subsequently, referring back to FIGS. 1 to 7, the cold water tank assembly 1 according to an exemplary embodiment of the present invention has an evaporator 300 disposed while passing through the heat exchange flow path zone H/A.

The evaporator 300 has a set length in the form of a pipe through which refrigerant flows, and is made of a metal material.

Meanwhile, as described above, the evaporator 300 is placed so that it can be drawn into the internal accommodation space S of the cold water tank 100 and then drawn out, and the evaporator 300 can be divided into an inlet line 300a side and an outlet line 300b side.

Although the drawing shows that the inlet line 300a and the outlet line 300b are provided in the first body part 110, but it is not limited thereto, and as necessary, of course, the inlet line 300a and the outlet line 300b may be provided in the second body part 120 according to the arrangement of the heat exchange flow path zone H/A, or one of them may be provided in the first body part 110 and the other may be provided in the second body part 120.

However, the outlet line 300b of the evaporator 300 has a structure that is drawn out from the evaporator 300 placed in the first heat exchange flow path zone H/A1 the same as the inlet pipe 130 (see FIG. 3), and the inlet line 300a of the evaporator 300 has a structure that is drawn in to be connected to the evaporator 300 placed in the last N^{th} heat exchange flow path zone H/An the same as the outlet pipe 140 (see FIG. 4).

Accordingly, the refrigerant injected into the evaporator 300 has a flow first passing through the last N^{th} heat exchange flow path zone H/An of the cold water tank 100 through the inlet line 300a, sequentially passing through the heat exchange flow path zone H/A, then finally passing through the first heat exchange flow path zone H/A1 and exiting to the outside of the cold water tank 100 through the outlet line 300b.

In other words, the order in which purified water at room temperature flows into the first heat exchange flow path zone H/A1 through the inlet pipe 130, sequentially passes through the heat exchange flow path zones H/A, and then passes through the last heat exchange flow path zone H/An has a flow in a direction opposite to the refrigerant flow order of the evaporator 300.

Usually, ice is created outside the evaporator 300 as the temperature drops in accordance with the order in which the refrigerant is injected and flows in the evaporator 300, and accordingly, in the cold water tank assembly 1 of the present invention, purified water at room temperature introduced through the inlet pipe 130 may be extracted to have a lower temperature of purified water (cold water) by sufficient heat exchange with ice generated even in the last heat exchange flow path zone H/An.

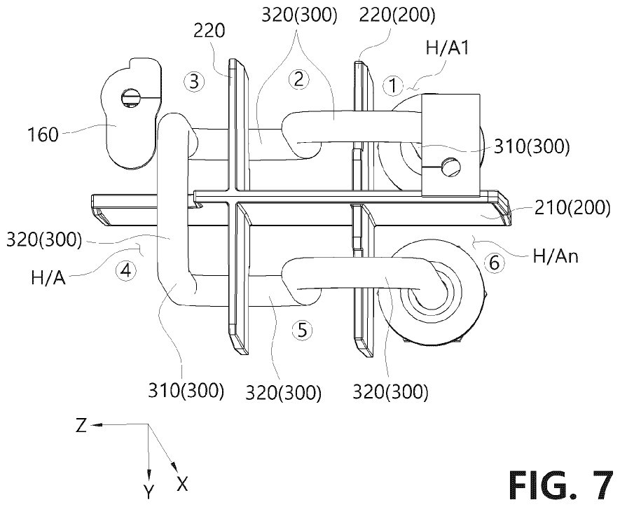

Meanwhile, the inlet line 300a of the evaporator 300 introduced into the accommodation space S of the cold water tank 100 is arranged to sequentially penetrate the plurality of heat exchange flow path zones H/A that divide the accommodation space S (see FIGS. 6 and 7).

Specifically, the evaporator 300 includes a main line 310 that is inserted into the accommodation space S and withdrawn to the outside while sequentially passing through the plurality of heat exchange flow path zones H/A and is arranged to pass through the heat exchange flow path zones H/A in the first direction, and a connection line 320 with which the end of the main line 310 is bent so that the main line 310 arranged adjacent in the heat exchange flow path zone H/A is connected.

As described above, the connection line 320 connects the main line 310 and the adjacent main line 310 while passing through the opening passage u1 formed by the partition wall parts 200 in the heat exchange flow path zone H/A.

Preferably, the main line 310 of the evaporator 300 is arranged to pass through the center line in the first direction of the heat exchange flow path zone H/A. Accordingly, purified water at room temperature passing through the heat exchange flow path zone H/A is in contact with the upper and lower portions of the ice generated in the main line 310, so that the temperature of the purified water is lowered more quickly. Accordingly, the rate of generating low-temperature purified water in the cold water tank assembly 1 according to an exemplary embodiment of the present invention becomes faster.

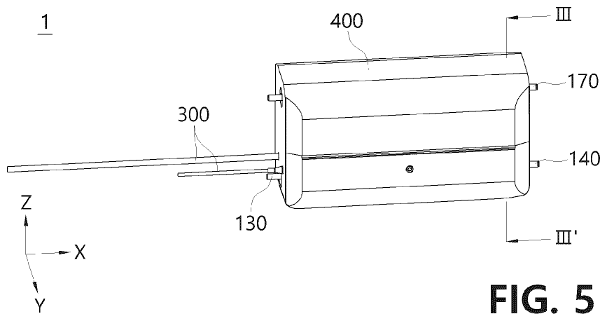

Meanwhile, referring back to FIGS. 5 and 6, the cold water tank assembly 1 according to an exemplary embodiment of the present invention further includes an insulating case 400 to increase insulation.

In this case, the insulating case 400 forms an interspace S/A (FIG. 6) between the outer circumferential surface of the cold water tank 100 and has a structure surrounding the cold water tank 100.

In this case, the interspace S/A may be in a form forming a space for vacuum insulation, or may be filled with an insulating material 410 as necessary.

And, referring back to FIGS. 1 to 5, as described above, the cold water tank assembly 1 according to an exemplary embodiment of the present invention includes a water level sensor 160, a temperature sensor 150, and an overflow pipe 170.

The water level sensor 160 is for checking the amount of purified water that is introduced into the cold water tank 100 and heat-exchanged, and is preferably arranged in the heat exchange flow path zone H/A formed at the uppermost portion in the third direction in the accommodation space S to measure the purified water level of the heat exchange flow path zone H/A.

For example, although the water level sensor 160 is provided at the upper portion of the second body part 120, it is not limited thereto, and of course, it may be provided in the first body part 110.

Meanwhile, the temperature sensor 150 is checking the purified water temperature, and is provided in any one of the plurality of heat exchange flow path zones to check the temperature of the purified water flowing through the heat exchange flow path zone. In this case, the temperature sensor 150 has a set length extending to the inside of the heat exchange flow path zone H/A.

In one embodiment, as illustrated, the temperature sensor 150 may be provided in the first heat exchange flow path zone H/A1 communicating with the inlet pipe 130, and check how fast the purified water at room temperature introduced through this is heat-exchanged in the first heat exchange flow path zone H/A1 to become purified water at low temperature (see FIG. 3).

Meanwhile, the location of the temperature sensor 150 is not limited thereto, and as necessary, of course, it may be provided in the last N^{th} heat exchange flow path zone H/An to measure the temperature of the low-temperature purified water discharged therefrom, or may be provided on the heat exchange flow path zone H/A at a specific location where ice is generated in the evaporator 300 to measure the purified water temperature of the ice generation location.

In other words, the installation position of the temperature sensor 150 is not limited. In addition, as necessary, of course, a plurality of temperature sensors 150 may be installed in the heat exchange flow path zone H/A at various locations.

Meanwhile, the overflow pipe 170 is provided to communicate with the heat exchange flow path zone H/A formed at the uppermost portion in the third direction in the accommodation space of the cold water tank 100.

This overflow pipe 170 serves to remove pressure and discharge internal purified water to the outside when overpressure is generated inside the cold water tank 100.

As described above, in the cold water tank assembly 1 according to an exemplary embodiment of the present invention, the introduced purified water is heat-exchanged in the plurality of heat exchange flow path zones H/A partitioned by the first partition wall 210 and the second partition wall 220, and the purified water at room temperature introduced into the first heat exchange flow path zone H/A1 is extracted as purified water at low temperature through the last N^{th} heat exchange flow path zone H/An, forming at least one rising flow in the third direction.

The plurality of heat exchange flow path zones H/A are formed in a set number according to the number and arrangement of the first partition wall 210 and the second partition wall 220 constituting the partition wall part 200.

The configuration of the partition wall part 200 may vary depending on the size of the water purifier in which the cold water tank assembly 1 is installed.

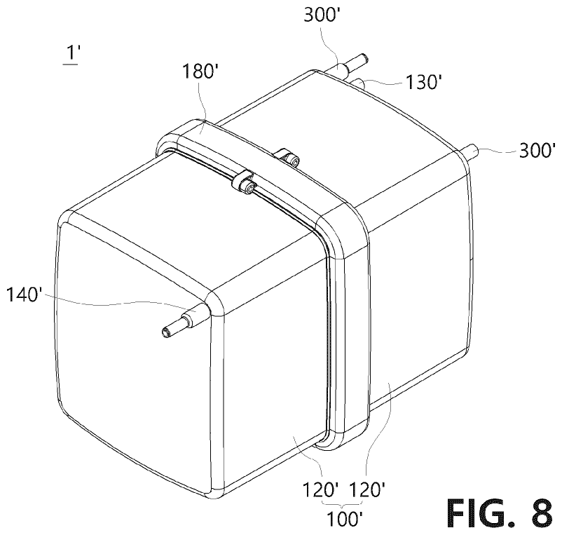

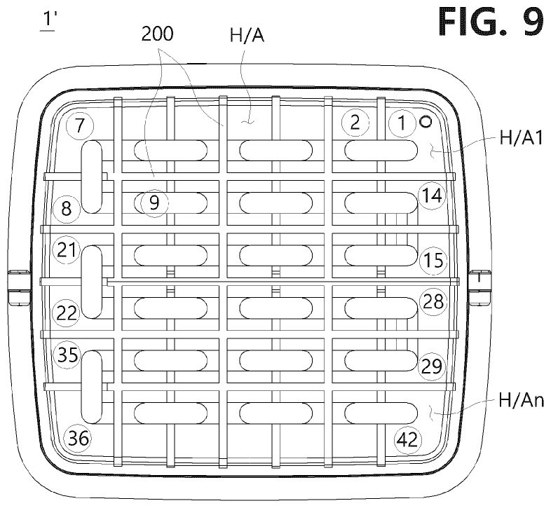

For example, as shown in FIGS. 8 and 9, the cold water tank assembly 1′ may have a structure of an extended cold water tank 100′ having from the first heat exchange flow path zone \textcircled{1}, which is the first heat exchange flow path zone H/A1 to the 42nd heat exchange flow path zone \textcircled{42}, which is the last heat exchange flow path zone H/An, according to the arrangement of the partition wall part 200.

In the cold water tank assembly 1′, a first body part 110′ and a second body part 120′ are hermetically coupled by a clamp 180′, an inlet pipe 130′ is formed on one side of the first body part 110′, and an outlet pipe 140′ is formed on one side of the second body part 120′.

As in the cold water tank assembly 1 of the embodiment described with reference to FIGS. 1 to 7, in the extended cold water tank assembly 1′, the introduced purified water is heat-exchanged in the plurality of heat exchange flow path zones H/A, and the purified water at room temperature introduced into the first heat exchange flow path zone H/A1 is extracted as purified water at low temperature through the last N^{th} heat exchange flow path zone H/An while forming at least one rising flow in the third direction.

Table 1 is a table comparing the cold water efficiency of the conventional cold water tank assembly and the cold water tank assembly 1 according to an exemplary embodiment of the present invention.

The conventional is a cold water tank assembly with an evaporator in a quadrangular tank structure for comparison; the cooling time is the time until the low-temperature purified water below 10° C. is extracted; random extraction temperature is the temperature of the low-temperature purified water extracted; and the number of cups of cold water-extracted represents the number of cups from which low-temperature purified water below 10° C. is extracted based on the amount of cold water extracted once per cup of 120 cc. And the cold water efficiency is the value obtained by dividing the cold water extraction amount by the tank specification (tank water volume).

TABLE 1
[Amount of cold water extracted once: 120 cc]

| | | | | Number of cups of cold |
|---|---|---|---|---|
| | Tank | Cooling time | Random extraction | water-extracted/ |
| | specification | (minute) | temperature | Cold water efficiency |
| Conventional | Bending closed type | 49 | 6.5/4.4/4.6/ | 5 cups/60% |
| | capacity 1.0 L | | 5.7/7.9/10.9 | |
| Present | Bending type | 38 | 6.8/4.5/4.8/ | 6 cups/72% |
| invention | 1,230 mm tank | | 5.8/7.4/9.6/13.6 | |
| | capacity 1.0 L | | | |

Referring to Table 1, it can be seen that in the conventional cold water tank assembly, the tank specification (tank water volume) is 1 L and the cooling time to extract cold water (low-temperature purified water) below 10° C. by operating an evaporator takes 49 minutes, and in this case, when cold water is randomly extracted until the extraction temperature exceeds 10° C., the number of cups of cold water extracted is 5 cups.

Meanwhile, it can be seen that in the cold water tank assembly according to the present invention, the cooling time to extract cold water (low-temperature purified water) below 10° C. by operating an evaporator takes 38 minutes when the tank specification (tank water volume) is 1 L as in the conventional, and in this case, when cold water is randomly extracted until the extraction temperature exceeds 10° C., the number of cups of cold water extracted is 6 cups.

In comparison, the cold water tank assembly 1 according to the present invention can reduce the cooling time to 38 minutes compared to the conventional cold water tank assembly, and while reducing the cooling time, the number of cold water extraction cups is higher than that of the conventional cold water tank assembly.

Accordingly, it may be confirmed that the cold water efficiency of the conventional cold water tank assembly is 60%, and the cold water efficiency of the cold water tank assembly of the present invention is 72%.

As such, it can be seen that the cold water tank assembly 1 according to an exemplary embodiment of the present invention clearly improves the tank cold water efficiency even when the tank capacity (tank water volume) is the same as the conventional cold water tank assembly.

Accordingly, the cold water tank assembly 1 according to an exemplary embodiment of the present invention can be miniaturized in size than the conventional one, thereby minimizing the design space of the water purifier.

As described above, the cold water tank assembly 1, l′ according to the present invention can increase the contact area between the purified water and the evaporator by dividing the accommodation space S inside the cold water tank 100 into a plurality of heat exchange flow path zones H/A using the first partition wall 210 on the XZ plane and the second partition wall 220 on the XY plane and forming the maximum heat exchange flow path zone H/A in a limited space.

In addition, the plurality of partition wall parts 200, including the first partition wall 210 on the XZ plane and the second partition wall 220 on the XY plane, divide the accommodation space into the plurality of heat exchange flow path zones H/A having a length in the first direction and adjacent in the second direction or third direction, and make purified water to have a rising flow at least once to increase the contact time between the purified water and the evaporator 300 to the maximum, thereby capable of increasing cooling efficiency and maximizing cold water extraction amount compared to capacity.

In addition, as the flow of refrigerant extracted by flowing into the evaporator 300 and the flow of purified water extracted by flowing into the heat exchange flow path zone H/A have opposite flows, the purified water extracted through the last heat exchange flow path zone H/An can be heat-exchanged with ice formed in the evaporator by the refrigerant and be extracted as the purified water having a lower temperature.

Although exemplary embodiments of the present invention have been described, the idea of the present invention is not limited to the embodiments set forth herein. Those of ordinary skill in the art who understand the idea of the present invention may easily propose other embodiments through supplement, change, removal, addition, etc. of elements within the same idea, but the embodiments will be also within the idea scope of the present invention.

What is claimed is:

1. A cold water tank assembly, comprising:
a cold water tank having an inlet pipe and an outlet pipe through which purified water flows, an accommodation space therein, and a length in a first direction;
a partition wall including at least one first partition wall configured to divide the accommodation space in a second direction in a plate shape with an XZ plane, and at least one second partition wall configured to cross the first partition wall and divides the accommodation space in a third direction in a plate shape with an XY plane, and dividing the accommodation space into a plurality of heat exchange flow path zones having a length in the first direction and adjacent to each other in the second direction or third direction; and
an evaporator through which refrigerant flows, the evaporator including a main line configured to be inserted into the accommodation space and withdrawn to the outside while sequentially passing through the plurality of heat exchange flow path zones and configured to be arranged to pass through the heat exchange flow path zones in the first direction, and a connection line with which an end of the main line is bent so that the main line adjacent is connected, and
wherein the partition wall forms an opening passage through which the connection line and the purified water pass while communicating the adjacent heat exchange flow path zones, and
wherein purified water at room temperature introduced into the first heat exchange flow path zone is extracted as purified water at low temperature passing through the last heat exchange flow path zone while forming at least one rising flow in the third direction.

2. The cold water tank assembly of claim 1, wherein the first partition wall and the second partition wall cross each other orthogonal to each other to form a lattice structure.

3. The cold water tank assembly of claim 2, wherein the main line is arranged to pass through a center line in the first direction of the heat exchange flow path zone.

4. The cold water tank assembly of claim 1, wherein an end edge of the partition wall is arranged to press an inner circumferential surface of the accommodation space of the cold water tank.

5. The cold water tank assembly of claim 1,
wherein the cold water tank comprises:
a coupling groove into which an end edge of the partition wall is forcibly fitted, on an inner circumferential surface of the cold water tank.

6. The cold water tank assembly of claim 1, wherein the cold water tank has a cross-sectional shape of a closed surface with a short axis in the second direction and a long axis in the third direction orthogonal to the second direction.

7. The cold water tank assembly of claim 1,
wherein the cold water tank assembly further comprises:
an insulating case configured to form an interspace between an outer circumferential surface of the cold water tank and surround the cold water tank.

8. The cold water tank assembly of claim 7, wherein the interspace forms a space for vacuum insulation, or is filled with an insulating material.

9. The cold water tank assembly of claim 1,
wherein the cold water tank comprises:
a first body having an enclosure shape and a first opening; and
a second body having an enclosure shape and a second opening in surface contact with and corresponding to the first opening, the second body being hermetically coupled to the first body.

10. The cold water tank assembly of claim 9,
wherein a part of the first partition wall or the second partition wall is integrally formed on an inner circumferential surface of the first body, and
wherein another part of the first partition wall or the second partition wall is integrally formed on an inner circumferential surface of the second body.

11. The cold water tank assembly of claim 1,
wherein the cold water tank further comprises:
a water level sensor configured to measure purified water level of the heat exchange flow path zone formed at the uppermost portion in the third direction in the accommodation space; and
a temperature sensor configured to measure the temperature of any one heat exchange flow path zone of the plurality of heat exchange flow path zones.

12. The cold water tank assembly of claim 11, wherein the temperature sensor is arranged in the first heat exchange flow path zone communicating with the inlet pipe.

13. The cold water tank assembly of claim 1,
wherein the cold water tank further comprises:
an overflow pipe configured to communicate with the heat exchange flow path zone formed at the uppermost portion in the third direction in the accommodation space.

14. The cold water tank assembly of claim 1, wherein a refrigerant flow of the evaporator and a purified water flow passing through the heat exchange flow path zone are formed to have opposite direction flows to each other.
